(19) United States
(12) Patent Application Publication
(10) Pub. No.: US 2017/0054225 A1
(43) Pub. Date: Feb. 23, 2017

(54) JOINT CONNECTOR AND WIRE HARNESS

(71) Applicant: Sumitomo Wiring Systems, Ltd., Yokkaichi, Mie (JP)

(72) Inventors: Hiroya SUZUKI, Yokkaichi, Mie (JP); Yasuhiro KAJIWARA, Yokkaichi, Mie (US)

(73) Assignee: Sumitomo Wiring Systems, Ltd., Mie (JP)

(21) Appl. No.: 15/118,568

(22) PCT Filed: Jan. 27, 2015
(86) PCT No.: PCT/JP2015/052162

§ 371 Date: Aug. 12, 2016

(30) Foreign Application Priority Data
Feb. 12, 2014 (JP) 2014-024334

(51) Int. Cl. H01R 4/18; H01R 11/12; H01R 9/03; H01R 4/02; H01R 4/64

(52) U.S. Cl. CPC H01R 4/186; H01R 4/023; H01R 4/64; H01R 9/031; H01R 11/12

(57) ABSTRACT

A joint connector and a wire harness in which a plurality of conductor portions exposed at ends of a plurality of covered electric wires can be reliably electrically connected to a joint portion of a joint terminal. They include a conductor holding member that has larger holes guiding cover portions of the covered electric wires so as to allow the cover portions abut from a side of one end face into which the covered electric wires are inserted and smaller holes allowing the conductor portions protruding from the cover portions to pass through to another end face.

### CROSS REFERENCE TO RELATED APPLICATIONS

This application claims the priority of Japanese patent application JP2014-024334 filed on Feb. 12, 2014, the entire contents of which are incorporated herein.

### TECHNICAL FIELD

The present invention relates to a joint connector and a wire harness.

### BACKGROUND ART

Conventionally, a joint connector having a configuration in which a plurality of conductor potions that are exposed from cover portions at the ends of a plurality of covered electric wires are held side-by-side between a main body and a cover, and the main body, the cover, and the conductor portions of the covered electric wires are electrically connected to each other is known as a joint connector for earthing that collectively grounds a plurality of covered electric wires connected to various electronic devices that are mounted on a vehicle such as a car (see Patent Document 1 (JP 2008-283796A), for example).

As shown in FIGS. 6 and 7, a conventional joint connector 10 for earthing as described above is constituted by a conductive main body 12 having one surface 12a in which a plurality of electric wire accommodating grooves 11 are formed side by side in the width direction of the main body 12, and a conductive cover 13.

The main body 12 has a configuration in which electric wires 14 whose bare wires 14a are exposed at the ends are inserted into the electric wire accommodating grooves 11. One end of the cover 13 is supported by one end of the main body 12, and the cover 13 rotates between a position at which the cover 13 stands erect on the main body 12 and a position where the cover 13 lies flat on the main body 12. Also, the cover 13 has a first pressing portion 15 and a second pressing portion 16 on an inner surface 13a opposing the opposite surface 12a when the cover 13 is placed flat on the main body 12.

When the cover 13 is placed flat on the main body 12, the first pressing portion 15 presses against the bare wires 14a of the electric wires 14 that are inserted into the electric wire accommodating grooves 11. And, when the cover 13 is placed flat on the main body 12, the second pressing portion 16 presses against cover portions 14b of the electric wires 14 that are inserted into the electric wire accommodating grooves 11.

The main body 12 has locking claws 17 on both sides in its width direction. When the cover 13 rotates until the cover 13 is placed flat on the main body 12, the locking claws 17 engage with the cover 13. The main body 12 has an earth terminal 18 that is to be joined to an earth portion of the vehicle (not shown).

The conventional joint connector 10 for earthing is such that when the electric wires 14 whose bare wires 14a are exposed at the ends are inserted into the electric wire accommodating grooves 11 of the main body 12, and the cover 13 is locked by the locking claws 17 of the main body 12 by rotating the cover 13 so as to be placed flat on the main body 13, the bare wires 14a of the electric wires 14 are pressed down by the first pressing portion 15 and the cover portions 14b of the electric wires 14 are pressed down by the second pressing portion 16. Thus, the bare wires 14a of the electric wires 14 come into close contact with the electric wire accommodating grooves 11 of the main body 12 and ground the earthing portion of the vehicle via the cover 13.

### SUMMARY OF INVENTION

However, if there is variation in the length of the exposed portions of the bare wires 14a due to variation in the length by which the electric wires 14 are stripped, sometimes, the cover portions 14b of the above-described conventional joint connector 10 for earthing enter a region in which the bare wires 14a are pressed by the first pressing portion 15. Thus, there is a concern that the first pressing portion 15 will press on the cover portions 14b of the electric wires 14, resulting in unreliable electrical connection between the bare wires 14a of the electric wires 14, the electric wire accommodating grooves 11 of the main body 12, and so on.

In view of this, the present invention has been made to resolve the above-described issues and an object of the design is to provide a joint connector and a wire harness in which a plurality of conductor portions that are exposed from the cover portions at the ends of a plurality of covered electric wires are reliably electrically connected to the joint portion of the joint terminal.

In order to achieve the above-described object, there is provided is a joint connector by which a plurality of conductor portions exposed from cover portions at ends of a plurality of covered electric wires arranged parallel to each other are joined in a bundled state, and are electrically connected. The joint connector includes a conductor holding member that has cover guide portions for guiding the cover portions of the plurality of covered electric wires so as to allow the cover portions to abut from a side of one end face into which the plurality of covered electric wires are inserted, and conductor passing portions allowing the conductor portions protruding from the cover portions to pass through to another end face, the conductor holding member holding the plurality of covered electric wires in a state in which tips of the plurality of conductor portions protrude from the conductor passing portions, and a joint terminal that has a joint portion for joining, in a bundled state, the tips of the plurality of conductor portions that protrude from the conductor holding member and are parallel to each other, and a connection terminal portion formed integrally with the joint portion.

With this configuration, when the covered electric wires are inserted into the cover guide portions from the one end face of the conductor holding member, the cover portions of the covered electric wires abut against the cover guide portions, and only the conductor portions of the covered electric wires protrude from the other end face of the conductor holding member to the outside. Therefore, the cover portions of the covered electric wires do not enter the joint portion of the joint terminal. Thus, because the conductive portions that protrude from the other end face of the conductor holding member to the outside can be attached to the connection terminal portion, the covered electric wires and the joint terminal are reliably electrically connected to each other.

In the joint connector having the above-described configuration, it is preferable that the conductor holding member has a plurality of conductor insertion holes into which the plurality of conductor portions are inserted.

With this configuration, when the conductor portions of the covered electric wires are inserted into the conductor insertion holes of the conductor holding member, the conductor portions are covered by the conductor holding member, and thus the conductor portions can be protected.

In the joint connector having the above-described configuration, it is preferable that the conductor holding member has a plurality of larger holes formed in the one end face such that the cover portions of the plurality of covered electric wires can be inserted respectively into the larger holes, a plurality of smaller holes formed closer to the other end face than the larger holes such that the plurality of conductor portions can pass through the smaller holes, and cover abutments formed between the larger holes and the smaller holes.

With this configuration, if the covered electric wires are inserted into the larger holes from the one end face of the conductor holding member, the cover portions of the covered electric wires abut against the cover abutments, and only the conductor portions of the covered electric wires protrude from the other end face of the conductor holding member to the outside. Therefore, the cover portions of the covered electric wires do not enter the joint portion of the joint terminal. Thus, the covered electric wires and the joint terminal can be reliably electrically connected to each other.

In the joint connector having the above-described configuration, it is preferable that the tips of the plurality of conductor portions are crimped to the joint portion.

With this configuration, the joint portion of the joint terminal is crimped to the conductor portions of the plurality of covered electric wires. Therefore, the covered electric wires and the joint terminal can be reliably electrically connected to each other.

In the joint connector having the above-described configuration, it is preferable that the tips of the plurality of conductor portions are welded to the joint portion.

With this configuration, the conductor portions of the plurality of covered electric wires are welded to the joint portion of the joint terminal. Therefore, the covered electric wires and the joint terminal can be reliably electrically connected to each other.

In order to achieve the above-described object, a wire harness may include an electric wire group constituted by a plurality of covered electric wires and the above-described joint connector.

With this configuration, in the wire harness when the covered electric wires are inserted into cover guide portions, conductor insertion holes, or larger holes of the conductor holding member, the cover portions of the covered electric wires abut against the cover guide portions or the cover abutments, and only the conductor portions of the covered electric wires protrude from the conductor holding member to the outside. Therefore, the cover portions of the covered electric wires do not enter the joint portion of the joint terminal. Thus, the covered electric wires and the joint terminal can be reliably electrically connected to each other.

Therefore, it is possible to provide a joint connector and a wire harness in which a plurality of conductor portions exposed from the cover portions at ends of the plurality of covered electric wires can be reliably electrically connected to the joint portion of the joint terminal.

### BRIEF DESCRIPTION OF DRAWINGS

FIG. 1 is a schematic longitudinal cross-sectional view of a joint connector according to an embodiment.

FIG. 2 is a view taken in direction A-A in FIG. 1.

FIG. 3 is a view of the conductor holding member in FIG. 1, viewed in the axial direction.

FIG. 4 is a cross-sectional view taken along B-B in FIG. 3.

FIG. 5 is diagram showing a state in which covered electric wires are inserted into the conductor holding member in FIG. 3.

FIG. 6 is a perspective view showing a state before the electric wires are inserted into the electric wire accommodating grooves in the conventional joint connector for earthing.

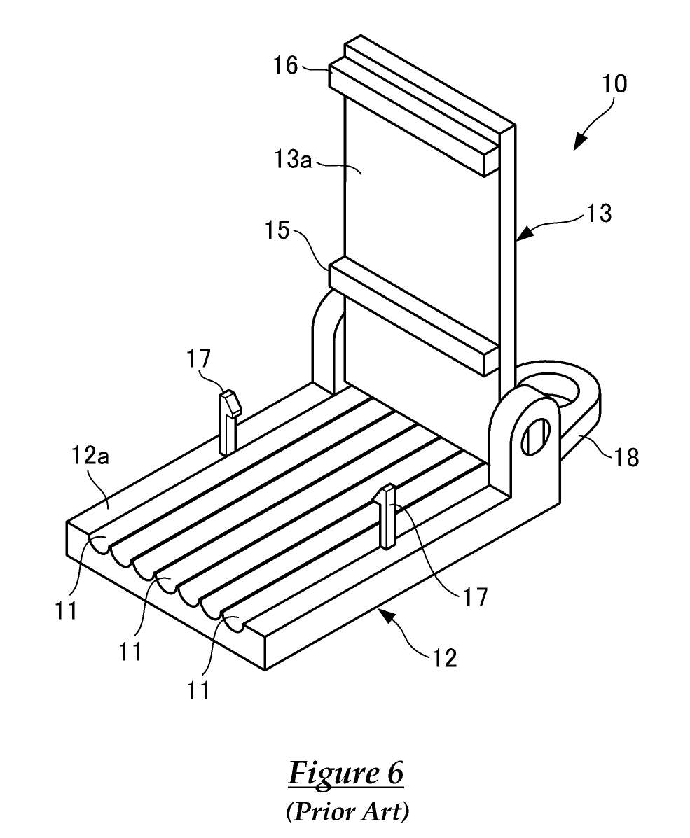

FIG. 7 is a perspective view showing a state after the electric wires are inserted into the electric wire accommodating grooves in the conventional joint connector for earthing.

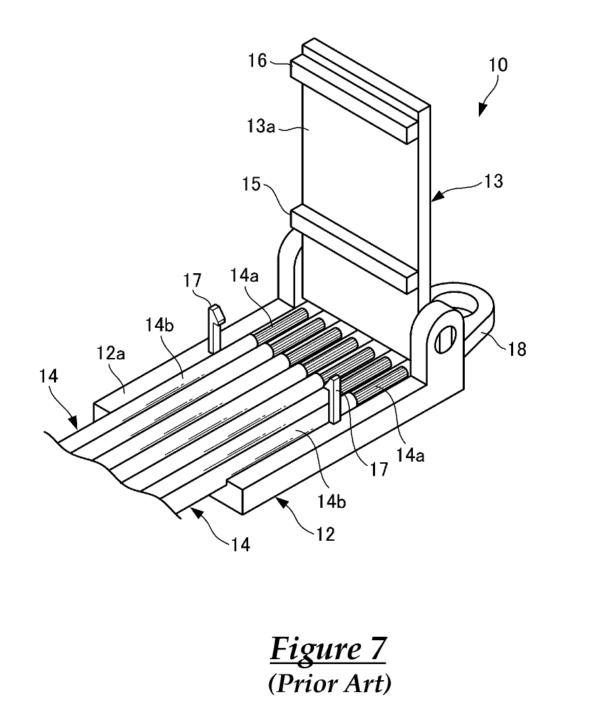

### DESCRIPTION OF EMBODIMENTS

Hereinafter, a joint connector and a wire harness according to an embodiment will be described with reference to the drawings.

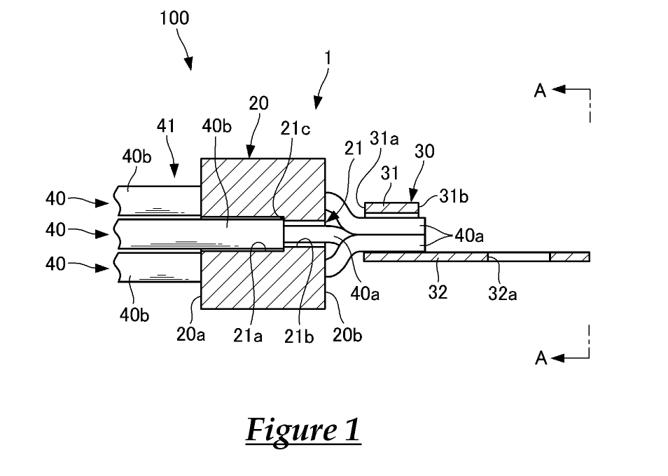

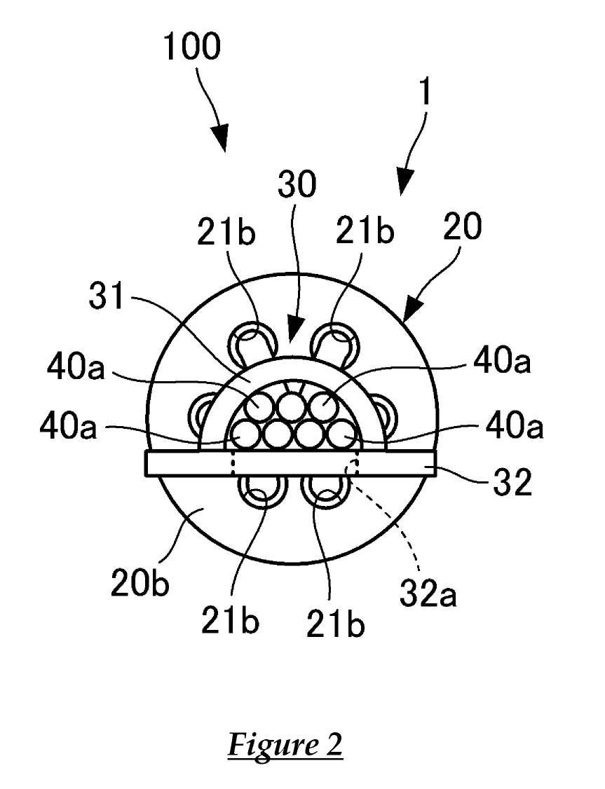

As shown in FIGS. 1 and 2, a wire harness 100 according to the present embodiment includes a joint connector 1 and an electric wire group 41, and is routed in a vehicle such as a car. The joint connector 1 includes a conductor holding member 20 and a joint terminal 30. The electric wire group 41 has a plurality of covered electric wires 40 that electrically connect electronic components mounted on the vehicle.

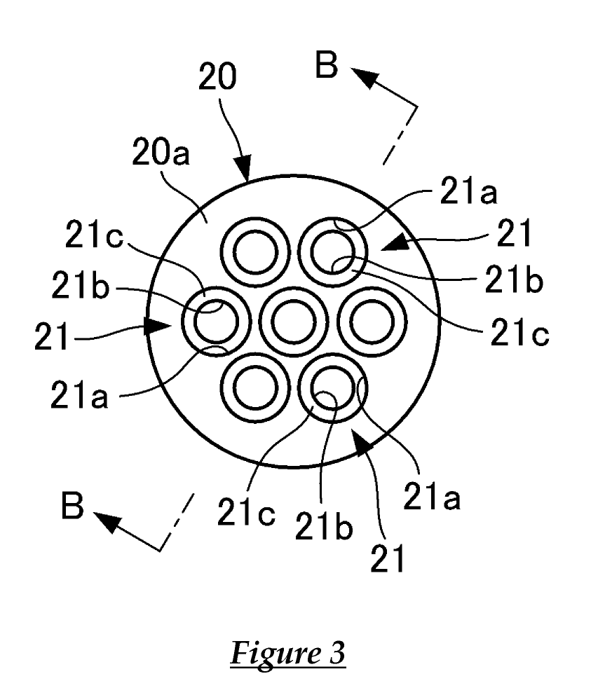

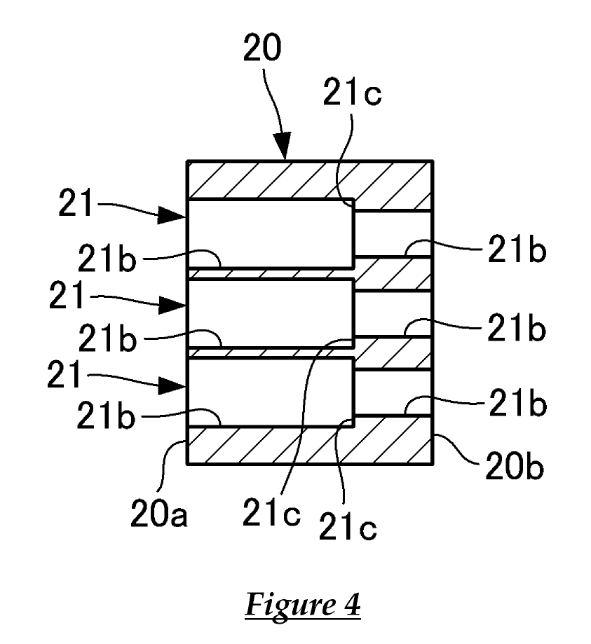

As shown in FIGS. 3 and 4, the conductor holding member 20 has an approximately cylindrical shape, and has a plurality of electric wire accommodating holes 21 that pass from one end face 20a to the other end face 20b. The conductor holing member 20 is not limited to the above-described shape, and may also have a rectangular columnar shape, a polygonal columnar shape, or the like. Also, the conductor holding member 20 need not be conductive, and may be made of either a resin material or a metal material.

The electric wire accommodating holes 21 include a plurality of larger holes 21a that extend in parallel to the axis of the conductor holding member 20 from the one end face 20a of the conductor holding member 20 toward the middle in the axial direction and a plurality of smaller holes 21b that are continuous and coaxial with the larger holes 21a and extend toward the other end face 20b of the conductor holding member 20. Furthermore, the electric wire accommodating holes 21 each have an annular cover abutment 21c that is approximately parallel to the one end face 20a and the other end face 20b of the conductor holding member 20, at the border between the larger hole 21a and the smaller hole 21b.

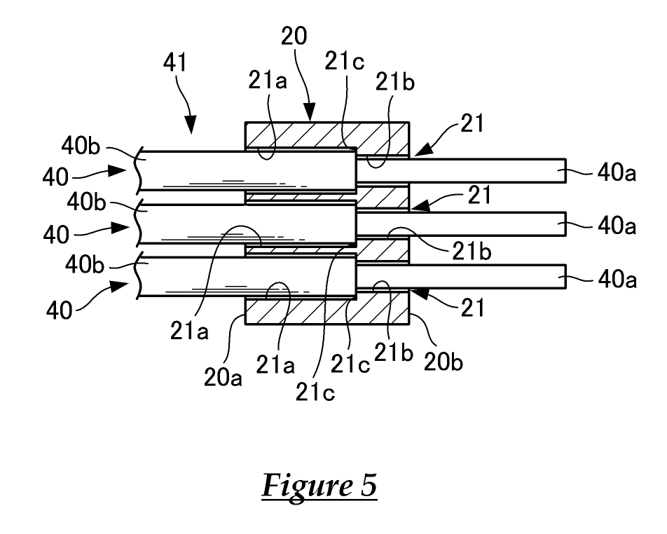

As shown in FIG. 5, the inner diameter of the larger hole 21a is set such that the portion of the covered electric wire 40 from which the cover portion 40b is not removed can be inserted into the larger hole 21a. These larger holes 21a and the cover abutments 21c constitute a cover guide portion that guides the cover portions 40b of the plurality of covered electric wires 40 so that they abut thereon from the side of the one end face 20a of the conductor holding member 20.

As shown in FIG. 5, the inner diameter of the smaller hole 21b is set such that the conductor portion 40a exposed from the cover portion 40b at the end of the covered electric wire 40 can be inserted into the smaller hole 21b. These smaller holes 21b constitute conductor insertion holes and conductor passing portions that allow the conductor portions 40a protruding from the cover portions 40b to pass through to the other end face 20b of the conductor holding member 20.

As shown in FIGS. 1 and 2, the joint terminal 30 includes a joint portion 31 that joins the tips of the plurality of conductor portions 40a in a bundled state, and a connection terminal portion 32 formed integrally (in one piece) with the joint portion 31. The joint terminal 30 is made of a metal material because it needs be conductive.

The joint portion 31 is a cylindrical body having a curved cross-sectional shape such that the tips of the plurality of conductor portions 40a can be inserted into the inner portion of the joint portion 31 and extending in the axial direction of the conductor holding member 20. One end portion 31a is provided on the side of the other end face 20b of the conductor holding member 20, and the tips of the plurality of conductor portions 40a can be inserted into the joint portion 31. The cross-sectional shape of the joint portion 31 may be a circular, rectangular, or open shape, for example.

The front end of the connection terminal portion 32 has a bolt hole 32a into which a bolt for earthing (not shown) is inserted, and the connection terminal portion 32 protrudes from the other end 31b of the joint portion 31 toward the side opposite to the conductor holding member 20.

As shown in FIGS. 1 and 5, the conductor portions 40a of the covered electric wires 40 are exposed from the cover portions 40b at the ends, and the covered electric wires 40 are inserted into the electric wire accommodating holes 21 from the one end face 20a to the other end face 20b of the conductor holding member 20.

The conductor portions 40a of the covered electric wires 40 are accommodated into the smaller holes 21b, and their tips protrude from the other end face 20b of the conductor holding member 20 to the outside. The cover portions 40b of the covered electric wires 40 are accommodated in the larger holes 21a, and their ends abut against the cover abutments 21c.

Furthermore, the tips of the conductor portions 40a of the covered electric wires 40 are inserted into the joint portion 31 of the joint terminal 30, and are electrically connected to the joint terminal 30. When the conductor portions 40a are electrically connected to the joint terminal 30, the joint portion 31 is crimped to the conductor portions 40a by subjecting the joint portion 31 to plastic deformation with a tool or the like, for example. Note that when the conductor portions 40a are electrically connected to the joint terminal 30, the conductor portions 40a and the joint portion 31 may be bonded by resistance welding, ultrasonic welding, or the like.

In the joint connector 1 according to the present embodiment, when the covered electric wires 40 are inserted into the electric wire accommodating holes 21 from the one end face 20a of the conductor holding member 20, the ends of the cover portions 40b accommodated in the larger holes 21a abut against the cover abutments 21c, and only the conductor portions 40a protrude from the smaller holes 21b from the other end face 20b of the conductor holding member 20 through the smaller holes 21b to the outside. Therefore, the cover portions 40b of the covered electric wires 40 do not enter the joint portion 31 of the joint terminal 30. Therefore, in the joint connector 1, the covered electric wires 40 and the joint terminal 30 can be reliably electrically connected.

Also, in the joint connector 1 according to the present embodiment, when the conductor portions 40a are inserted into the smaller holes 21b, the conductor portions 40a are covered by the conductor holding member 20, and thus the conductor portions 40a can be protected.

As described above, the joint connector and the wire harness according to the present invention have the effect of reliably electrically connecting the plurality of conductor portions exposed from the cover portions at the ends of the plurality of covered electric wires to the joint portion of the joint terminal, and are useful for general joint connectors and wire harnesses that are adopted in vehicles, various apparatuses, mechanical equipment, and the like.

### REFERENCE SIGNS LIST

1 Joint connector
20 Conductor holding member
20a One end face
20b Other end face
21a Larger hole (cover guide portion)
21b Smaller hole (conductor passing portion, conductor insertion hole)
21c Cover abutment
30 Joint terminal
31 Joint portion
32 Connection terminal portion
40 Covered electric wire
41 Electric wire group

1. A joint connector for joining, in a bundled state, and electrically connecting a plurality of conductor portions exposed from cover portions at ends of a plurality of covered electric wires arranged parallel to each other, the joint connector comprising:
a conductor holding member that has cover guide portions for guiding the cover portions of the plurality of covered electric wires so as to allow the cover portions to abut from a side of one end face into which the plurality of covered electric wires are inserted, and conductor passing portions allowing the conductor portions protruding from the cover portions to pass through to another end face, the conductor holding member holding the plurality of covered electric wires in a state in which tips of the plurality of conductor portions protrude from the conductor passing portions; and
a joint terminal that has a joint portion for joining, in a bundled state, the tips of the plurality of conductor portions that protrude from the conductor holding member and are parallel to each other, and a connection terminal portion formed integrally with the joint portion,
wherein the conductor holding member holds the conductor portions of the plurality of covered electric wires in parallel to an axis,
the joint portion of the joint terminal extends in an axial direction of the conductor holding member,
the conductor portions arranged in parallel to each other in the conductor holding member are bundled towards the axis of the conductor holding member between the other end face of the conductor holding member and the joint portion of the joint terminal.

2. The joint connector according to claim 1, wherein the conductor holding member has a plurality of conductor insertion holes into which the plurality of conductor portions are inserted.

3. The joint connector according to claim 1, wherein the conductor holding member has a plurality of larger holes formed in the one end face such that the cover portions of the plurality of covered electric wires can be inserted respectively into the larger holes, a plurality of smaller holes formed closer to the other end face than the larger holes such that the plurality of conductor portions can pass through the smaller holes, and cover abutments formed between the larger holes and the smaller holes.

4. The joint connector according to claim 1,
wherein the joint portion of the joint terminal has a curved cross-sectional shape, and
the tips of the plurality of conductor portions are crimped to the joint portion.

5. The joint connector according to claim 1, wherein the tips of the plurality of conductor portions are welded to the joint portion.

6. A wire harness comprising an electric wire group constituted by a plurality of covered electric wires and the joint connector according to claim 1.
